(19) United States
(12) Patent Application Publication
(10) Pub. No.: US 2026/0035222 A1
(43) Pub. Date: Feb. 5, 2026

(54) HANDLING MACHINE COMPRISING A SYSTEM OF SOLENOID VALVES FOR CONTROLLING A HYDRAULIC ACTUATING DEVICE OF A MEMBER OF THE MACHINE

(71) Applicant: MANITOU BF, ANCENIS (FR)

(72) Inventor: Olivier CAGET, ANCENIS (FR)

(21) Appl. No.: 19/271,155

(22) Filed: Jul. 16, 2025

(30) Foreign Application Priority Data
Aug. 1, 2024 (FR) 2408512

(51) Int. Cl. B66F 9/065; B66F 9/075; B66F 9/22

(52) U.S. Cl. CPC B66F 9/0655; B66F 9/07509; B66F 9/22

(57) ABSTRACT

The invention relates to a handling machine comprising a hydraulically actuable member (OF), a hydraulic actuating device (DA) configured to actuate the member (OF); a system of solenoid valves (EV1, EV2); a hydraulic connecting line (LR) between the solenoid valves; a pressure sensor (CP1) in the connecting line (LR); a feed line (LA) which connects the second solenoid valve (EV2) to the actuating device (DA), a pressure sensor (CP2) in the feed line (LA). The control system (130) is configured to detect a malfunction of at least one of the solenoid valves (EV1, EV2) depending on one or more pressures measured by the or one of the pressure sensors (CP1, CP2) and on the electrically powered state of one or more solenoid valves.

### FIELD OF THE INVENTION

The present invention relates generally to a handling machine comprising a system of solenoid valves for controlling a hydraulic actuating device of a member of the machine, such as a braking member.

### PRIOR ART

Solutions for verifying the operating state of a system for controlling a hydraulic actuating device of a braking and brake release member of the machine are known from the prior art. This verification process involves verifying whether a solenoid valve changes position in accordance with a position-change instruction which is transmitted by an associated control system. The position-change instruction may correspond to an electrically powered state of the solenoid valve for putting it into a first position or to a non-electrically powered state of the solenoid valve for allowing it to be returned, for example by way of a spring, into a second position.

However, according to these solutions known from the prior art, the machine cannot move over the ground during the verification process. It can take time, however, to carry out the known verification (diagnostic) process, especially in cold weather, while developments in safety standards require more frequent verifications of the operating state of the solenoid valves for controlling a handling machine. This problem, which arises for a braking and brake release member, can also arise for other operating members of the machine that are actuable by a hydraulic actuating device.

It is thus desirable to reduce the time taken for diagnosing the operation of the system for controlling a hydraulic actuating device for a member of the machine.

The aim of the present invention is to provide a novel machine for at least partially overcoming one or more of the problems set out above.

### SUMMARY OF THE INVENTION

To this end, the subject of the invention is a handling machine comprising a rolling chassis (or dolly), a drive system for moving the machine over the ground, and a handling system carried by the rolling chassis, the handling machine also comprising:
a hydraulically actuable member, such as a braking and brake release member;
a hydraulic actuating device configured to actuate said member;
a hydraulic circuit comprising an oil reservoir, a discharge (or delivery) line communicating with the reservoir, and a pressure line for actuating said member when the hydraulic actuating device is placed in hydraulic communication with the pressure line;
a control system comprising a first control unit and a second control unit, and a system of solenoid valves which comprises a first two-way solenoid valve, which is controllable by the first control unit, and a second two-way solenoid valve, which is controllable by the second control unit;
a hydraulic connecting line between the solenoid valves;
a first sensor, referred to as first pressure sensor, configured to measure a parameter representative of the hydraulic pressure in the connecting line;
a hydraulic feed line for the actuating device, which connects the second solenoid valve to the actuating device,
a second sensor, referred to as second pressure sensor, configured to measure a parameter representative of the hydraulic pressure in the feed line;
the first solenoid valve being movable between:
a discharge position in the non-electrically powered state of the first solenoid valve, in which the connecting line is in communication with the reservoir, and a hydraulic feed position, in the electrically powered state of the first solenoid valve, in which the connecting line is in communication with the pressure line,
the second solenoid valve being movable between:
a discharge position, in the non-electrically powered state of the second solenoid valve, in which the feed line of the actuating device is in communication with the reservoir, and a hydraulic feed position, in the electrically powered state of the second solenoid valve, in which the feed line of the actuating device is in communication with the connecting line;
the control system being configured to detect a malfunction of at least one of the solenoid valves depending on one or more pressures measured by the or one of the pressure sensors and on the electrically powered state of one or more solenoid valves.

The use of pressure sensors and the arrangement thereof with the two solenoid valves of the system of solenoid valves makes it possible to quickly and easily verify (diagnose) the operating state of one or of each of said solenoid valves. The cost of such a solution is also limited.

The comparison of the pressure values measured by the sensors with threshold values makes it possible to quickly verify whether one and/or the other of the solenoid valves changes position in accordance with a position change request output by the associated control unit. The pressure measurement makes it possible to determine whether the controlled state (electrically powered or not electrically powered) of the associated solenoid valve is consistent with the measured pressure. Taking the measured pressure and the controlled state for each solenoid valve of the system of solenoid valves into account in this way thus contributes to ensuring the safety of the machine.

The verification of the operation of the system of solenoid valves can be carried out in real time or on demand, as soon as an action is initiated on the machine, such as an action moving the machine over the ground and/or a handling action.

If faulty operation of at least one solenoid valve is detected, a process of putting the machine into safety mode can be initiated, in which, for example, the movement of the machine over the ground and/or the actuation of the handling system is prevented or limited. Provision may also be made for the machine to enter safety mode if a fault is detected on at least one of the solenoid valves. According to one particular aspect, safety mode is entered in such a way as to require an intervention to be carried out on the machine to remedy the fault before the machine can be reused.

Preferably, each solenoid valve of the system of solenoid valves is associated with a control unit which is configured to acquire a pressure value measured by the sensor associated with the solenoid valve and which is independent of the control unit of the other solenoid valve. Any operating faults can thus be detected separately on each solenoid valve of the system of solenoid valves, thereby improving the reliability of the process of verifying the operating state of the system of solenoid valves.

According to one embodiment, the member of the machine that is actuable by the hydraulic actuating device that is controllable by the system of solenoid valves is a braking and brake release member which is part of a so-called negative brake system. In other words, in the absence of hydraulic pressure applied to the braking member, the element of the machine that is intended to be braked or to be released from braking, such as one or more wheels of the machine, is braked.

The system may also comprise one or more of the following features, in any technically admissible combination.

According to one embodiment, with the machine comprising a processing system, which may comprise the control system, said processing system making it possible to control the movement of the machine over the ground and the actuation of the handling system,
if a malfunction of at least one of said solenoid valves is detected by the control system, the processing system is configured to stop or limit the movement of the machine over the ground and/or to stop or limit the actuation of the handling system.

According to one embodiment, on receiving a first instruction for controlling the actuating device, such as a brake release command, the control system is configured to:
a) power the first solenoid valve so as to make it possible to place the connecting line in communication with the pressure line,
b) if the pressure measured by the first sensor is greater than or equal to a first threshold value, and if the pressure measured by the second sensor is less than a second threshold value, the second control unit causes the second solenoid valve to be electrically powered in order to place the feed line of the member in communication with the connecting line which is already in communication with the pressure line via the first solenoid valve,
otherwise, the control system generates a signal indicating detection of a malfunction of at least one of the solenoid valves.

According to one embodiment, before step a), if the pressure measured by the first sensor is greater than or equal to the first threshold value, the control system, preferably the first control unit, generates a signal indicating detection of a malfunction of the first solenoid valve.

According to one embodiment, between steps a) and b), if the pressure measured by the second sensor is greater than or equal to the second threshold value, the control system, preferably the second control unit, generates a signal indicating detection of a malfunction of the second solenoid valve.

According to one embodiment, on receiving a second instruction for controlling the actuating device, such as a braking command, the control system is configured to:
c) cut the electric power supply of the second solenoid valve to allow it to be in a discharge position in which the feed line of the actuating device is in communication with the reservoir,
d) preferably, cut the electric power supply of the first solenoid valve to allow it to be in a discharge position in which the connecting line is in communication with the reservoir.

According to one embodiment, between steps c) and d), if the pressure measured by the second sensor is greater than or equal to the second threshold value, the control system, preferably the second control unit, is configured to generate a signal indicating detection of a malfunction of the second solenoid valve.

According to one embodiment, after step d), if the pressure measured by the first sensor is greater than or equal to the first threshold value, the control system, preferably the first control unit, is configured to generate a signal indicating detection of a malfunction of the first solenoid valve.

According to one embodiment, the actuating device comprises a hydraulic valve.

According to one embodiment, the actuating device comprises a hydraulic distributor.

According to one embodiment, the member that is actuable by the actuating device is a braking and brake release member.

### BRIEF DESCRIPTION OF THE DRAWINGS

Further features and advantages of the invention will also become apparent from the following description, which is purely illustrative and non-limiting and should be read in conjunction with the appended drawings, in which:

FIG. 1 is a schematic view of a handling machine according to one embodiment of the invention;

FIG. 2 is a view of the circuit of a part of a hydraulic circuit of a handling machine, which comprises a hydraulic actuating device of a member of the machine, and a system of solenoid valves configured to manage the hydraulic communication between the actuating device, on one side, and the pressure line and the discharge line of the hydraulic circuit, on the other side, according to one embodiment of the invention, the solenoid valves being in a discharge position; a feed line of the actuating device being provided with a pressure sensor and a connecting line between the two solenoid valves also being provided with a pressure sensor;

FIG. 3 is a view of the circuit in FIG. 2, with one solenoid valve of the system of solenoid valves placed in a hydraulic feed position, such that the connecting line between the two solenoid valves is in hydraulic communication with the pressure line, this being detected by the first sensor and being identified as correct operation of the first solenoid valve;

FIG. 4 is a view of the circuit in FIG. 3, in a configuration in which, following the pressure measurement by the sensor of the connecting line, the second solenoid valve is electrically powered and so the connecting line, fed by the pressure line, is placed in communication with the feed line of the actuating device, this being detected by the second sensor and being identified as correct operation of the second solenoid valve;

FIG. 5 is a view of the circuit in FIG. 4, in a configuration in which the second solenoid valve is no longer electrically powered and so the second solenoid valve is returned into a discharge position in which the feed line is placed in communication with the discharge line of the reservoir;

FIG. 6 is a view of the circuit in FIG. 5, in a configuration in which the first solenoid valve is no longer electrically powered and so the first solenoid valve is returned into a discharge position in which the connecting line is placed in communication with the discharge line of the reservoir;

FIG. 7 is a view of the circuit in FIG. 2, in a configuration in which the first solenoid valve is locked in the hydraulic feed position and so, in spite of the electric power supply of the solenoid valve being stopped or absent, the connecting line remains under pressure, as is measured by the first sensor, this being identified as a malfunction of the first solenoid valve;

FIG. 8 is a view of the circuit in FIG. 2, in a configuration in which the second solenoid valve is locked in the hydraulic feed position and so, in spite of the electric power supply of the solenoid valve being stopped or absent, the feed line remains in communication with the connecting line, the first solenoid valve being in the return position;

FIG. 8A is a view of the circuit in FIG. 8, in a configuration in which the first solenoid valve is placed in a hydraulic feed position such that the connecting line is under pressure, and the hydraulic feed line is in communication with the connecting line, while the controlled state of the second solenoid valve is a non-electrically powered state, this being identified as a malfunction of the second solenoid valve;

FIG. 9 is a view repeating the configuration of the circuit in FIG. 4, the two solenoid valves being electrically powered and being in the hydraulic feed position;

FIG. 9A is a view of the circuit in FIG. 9, in a configuration in which the second solenoid valve is no longer electrically powered so as to return to the discharge position, the first solenoid valve remaining electrically powered and being in the hydraulic feed position;

FIG. 9B is a view of the circuit in FIG. 9A, in a configuration in which the second solenoid valve remains in the discharge position, the first solenoid valve no longer being electrically powered but being locked so that it remains in the hydraulic feed position, this being detected by the pressure sensor of the connecting line and being identified as a malfunction of the first solenoid valve;

FIG. 10 is a view repeating the configuration of the circuit in FIG. 9, the two solenoid valves being electrically powered and being in the hydraulic feed position;

FIG. 10A is a view of the circuit in FIG. 10, in a configuration in which the second solenoid valve is no longer electrically powered but locked so that it remains in the hydraulic feed position, the first solenoid valve remaining electrically powered and being in the hydraulic feed position, such that the feed line remains under pressure, this being detected by the second sensor and being identified as a malfunction of the second solenoid valve;

FIG. 10B is a view of the circuit in FIG. 10A, in a configuration in which the first solenoid valve is no longer electrically powered so as to return to the discharge position, such that the feed line is in communication with the discharge line via the connecting line between the two solenoid valves, this allowing the oil present in the feed line to be delivered into the reservoir.

### DETAILED DESCRIPTION

Embodiments are described in the following text with reference to the appended drawings. Similar numerals refer to similar elements throughout the drawings. However, the invention can be implemented in numerous different forms and should not be interpreted as being limited to the embodiments set out here. The scope of the invention is defined by the appended claims.

A reference throughout the specification to “an/one embodiment” means that a particular functionality, structure or feature described in relation to one embodiment is included in at least one embodiment of the present invention. Thus, the use of the expression “in one embodiment” at various points throughout the specification does not necessarily refer to the same embodiment. Moreover, the particular functionalities, structures or features can be combined in any appropriate manner in one or more embodiments.

With reference to the figures, a handling machine is shown which comprises a system of solenoid valves EV1, EV2 for controlling a hydraulic actuating device DA of a member OF of the machine. In the rest of the description, said member of the machine is or comprises a braking and brake release member, in particular a braking and brake release member of a spring applied hydraulically released vehicle brake system. Provision may be made for the braking and brake release member to make it possible to brake or release the braking of a plurality of elements or for said braking and brake release member of the machine to comprise one braking and brake release member per element to be braked or to be released from braking.

Said element to be braked is, for example, one or more wheels of the vehicle. In the event of failure of the system of solenoid valves, if the solenoid valves remain locked in an open position (hydraulic feed configuration), the wheel or wheels associated with the braking and brake release member remain released from braking, even if the operator actuates the brake pedal. It is therefore important to monitor proper operation of the solenoid valves before allowing the machine to move over the ground.

Furthermore, the solution according to the invention, which is based on the detection of pressure downstream (considered in the case of pressurization of the member of the machine) of each solenoid valve makes it possible to carry out monitoring rapidly, this making it possible not to disturb the operator, in order that they do not have to activate their movement command several times for lack of sufficient reactivity of the machine, which would impair normal use of the machine and cause incomprehension on the part of the operator.

The invention also applies to other types of members of the machine, in particular for safeguarding one or more hydraulic power members.

The hydraulic actuating device DA interposed between the system of solenoid valves and the member of the machine to be actuated (for releasing braking in the case of a negative brake) or to be left free (for returning into a braking position) may be a hydraulic valve for controlling said member. In a variant, the hydraulic actuating device DA may be a hydraulic distributor that is able to feed different hydraulic members, such as hydraulic cylinders, of the handling system of the machine. The hydraulic cylinders may comprise a cylinder for controlling the angle of a lift arm, referred to as lift cylinder, a cylinder for controlling the extension of the arm when the latter is telescopic, referred to as telescoping cylinder, or a cylinder for controlling the inclination of a tool or carriage at the end of the arm, referred to as inclination cylinder.

Said braking and brake release member and the hydraulic actuating device may form all or part of a spring applied hydraulically released vehicle brake system, also referred to as a negative brake system.

According to this embodiment, the braking and brake release member is able to take up a configuration braking at least one element of the machine, such as a wheel of the vehicle, and a return system, for example a spring system, makes it possible to return the braking and brake release member into the braking configuration. The braking and brake release member is also able to take up a release (or brake release) configuration by virtue of a hydraulic control circuit which makes it possible to put the braking and brake release member into said release configuration.

The hydraulic control circuit comprises the system of solenoid valves EV1, EV2 presented below.

As mentioned above, the description given below in the context of a braking member of a negative brake system is applicable to other types of members of the machine that are hydraulically actuable.

### Handling Machine

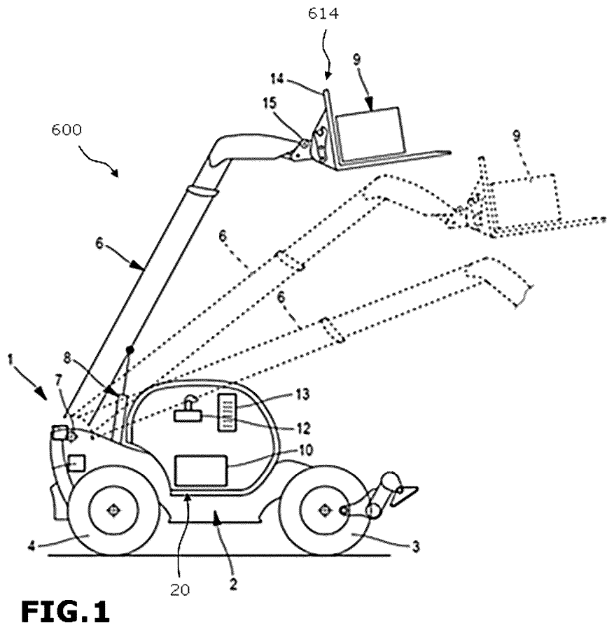

The handling machine 1 may be of the telescopic arm truck type, as illustrated, for example, in FIG. 1, or some other type, for example a bucket truck or a mast truck.

The handling machine 1 comprises a chassis 2. Preferably, the chassis is a rolling chassis 2 that is supported on the ground via a front axle 3 and a rear axle 4.

The handling machine 1 comprises a motorized system for moving the machine over the ground. The motorized system for moving the machine comprises, for example, an electric motor and/or an internal combustion engine, and a system for transmission to the wheels and for steering control, for steering the movement of the machine.

The rolling chassis 2 supports a handling system 600 and an actuating system for moving said handling system with respect to the chassis 2. The handling system 600 may also be a personnel handling system.

In the examples illustrated, the handling system comprises an arm 6, usually referred to as lift arm, which is articulated on the chassis 2 in order to be able to be moved between a so-called lowered position and a lifted position. In the case of a mast truck, the handling system comprises a mast equipped with a fork system mounted slidably along the mast. The handling machine 1 may also be of the bucket truck type with a handling system which may comprise a lift arm or a scissor system.

The handling machine includes a processing system 10 comprising for example one or more computers, allowing the operator, via a human-machine interface (which may comprise a driving member, such as a joystick), to control the handling machine, and in particular to control the movement of the machine and/or the handling system, such as the position of the arm 6.

In the example in FIG. 1, the rolling chassis 2 comprises a cab 20 having a door allowing an operator to get into the cab 20 in order to control the machine. Provision may be made for the machine to be provided with a screen 13, for example for displaying a message relating to a malfunction signal.

The lift arm 6 (or handling arm) is mounted on the chassis 2 and able to be oriented about an axis of rotation (axis of rotation referenced 7 in FIG. 1). In particular, said axis of rotation 7 is horizontal when the rolling chassis 2 is standing on horizontal ground. The arm 6 protrudes towards the front of the machine. According to one embodiment, the axis of rotation 7 is closer to the rear axle than to the front axle of the machine. The arm 6 may also be mounted on a turret mounted rotatably on the chassis of the machine.

The handling system, such as the arm 6, is equipped with a load or personnel handling device 614. As in the example illustrated in FIG. 1, the handling device 614 may comprise a load carrier 14, such as a fork or bucket system, which is articulated on the arm 6 by a link 15 and configured to carry a payload 9.

Advantageously, the arm 6 is of the telescopic type. The arm 6 thus comprises at least two extendable segments, for example by means of an extension cylinder (not shown) arranged between the at least two segments. In a variant, the arm may be a non-telescopic arm.

The actuating system of the arm includes a lift actuator, for example a hydraulic cylinder 8, which makes it possible to move the arm 6 upwards and downwards about the horizontal axis 7, driven by a control system. In a variant, the lift actuator may be an electric cylinder. The control system may comprise at least one control member 12, such as a joystick, or a control console which communicates with the processing system 10 of the machine.

The processing system 10 may be configured to control the lift cylinder, and the possible other cylinder or cylinders, for example via a hydraulic circuit depending on the request made by the operator of the control system.

The handling machine comprises a hydraulic circuit, which may include the abovementioned hydraulic circuit for cylinder control, in order to make it possible to actuate one or more hydraulic actuators of the machine.

The hydraulic circuit of the machine comprises a hydraulic pressure source, such as a hydraulic pump, which makes it possible to pressurize oil in a line, referred to as pressure line LP, of the hydraulic circuit, and an oil reservoir T into which the oil can be delivered via a discharge line LT. The hydraulic circuit may comprise a hydraulic distributor.

In the rest of the description, a part of the hydraulic circuit will be addressed which comprises a system of solenoid valves EV1, EV2, in connection with a hydraulic actuating device DA of a member OF of the machine (which, in the example described, is a braking and brake release member of a negative brake system), the operating state of which is intended to be verified.

### Verification of the Operating State of the System of Solenoid Valves

The machine comprises a system for verifying the operating state of the system of solenoid valves EV1, EV2 which forms the system for controlling the actuating device DA of said operating member OF of the machine. The operating state of the system of solenoid valves EV1, EV2 is verified by a pressure measurement using a first pressure sensor CP1 positioned on a hydraulic connecting line LR between the solenoid valves EV1, EV2 of the system of solenoid valves EV1, EV2, and a second pressure sensor CP2 positioned on a feed line LA between the second solenoid valve EV2 and the actuating device DA.

The machine comprises a solenoid valve control system 130 which may form part of the processing system 10 of the machine. The control system 130 for the solenoid valves EV1 and EV2 comprises a control unit 110 for controlling the first solenoid valve EV1 and a control unit 120 for the second solenoid valve EV2. The control units 110 and 120 are preferably separate from one another. According to a less advantageous variant, provision may nevertheless be provided for the control units 110 and 120 to be a single control unit.

The first solenoid valve EV1 is thus controllable by the first control unit 110, and the second solenoid valve EV2 is controllable by the second control unit 120. The first control unit 110 and the second control unit 120 may be considered to form part of the processing system 10 of the machine.

The hydraulic circuit comprises a connecting line LR between the solenoid valves EV1 and EV2, on which line a pressure sensor CP1 is positioned. In other words, the solenoid valves EV1 and EV2 are in series. The hydraulic circuit comprises a feed line LA for the operating member OF, which connects the second solenoid valve EV2 to an actuating device DA of the member OF, and on which a pressure sensor CP2 is positioned.

Where it is indicated that the control system 130 is configured to carry out a given action, this action may be carried out by the control unit 110 and/or 120. Preferably, the control unit 110 carries out an action in connection with the solenoid valve EV1 with which it is associated, and the control unit 120 carries out an action in connection with the solenoid valve EV2 with which it is associated. The control system 130 is configured to make it possible to detect a malfunction of at least one of the solenoid valves EV1, EV2 depending on one or more pressures measured by the or one of the pressure sensors CP1, CP2 and on the controlled state of the solenoid valves by the control units 110, 120.

The hydraulic circuit also comprises the pressure line LP, and a discharge (delivery or return) line to the reservoir T. The discharge line LT comprises a branch connected to the solenoid valve EV1 and another branch connected to the solenoid valve EV2.

As explained above, provision may be made for the first unit 110 and the second unit 120 to be formed by a single control unit, but preferably the units are separate from one another to make it easier to detect a malfunction of the system.

The first solenoid valve EV1 is movable between a return position when the solenoid valve EV1 is not electrically powered, in which case the connecting line LR is in communication with the reservoir T, and a so-called activation position, in the electrically powered state, in which case the connecting line LR is in communication with the pressure line LP. In this position, the pressure sensor CP1 detects a pressure greater than or equal to a first threshold value corresponding to the pressurization of the connecting line LR.

The electrically powered or non-electrically powered state of each solenoid valve EV1, EV2 is controlled by the corresponding control unit 110, 120.

The second solenoid valve EV2 is movable between a return position when the solenoid valve EV2 is not electrically powered, in which case the feed line LA of the actuating device DA is in communication with the reservoir T, and a so-called activation position, in the electrically powered state, in which case the feed line LA of the actuating device DA is in communication with the connecting line LR. In this position, the pressure sensor CP2 detects a pressure greater than or equal to a second threshold valve corresponding to the pressurization of the feed line LA.

Thus, when the solenoid valves EV1 and EV2 are each returned into the delivery position, i.e. are not electrically powered, the actuating device DA is not hydraulically pressurized, and so it does not act on the member OF of the machine.

Thus, when said member OF is a braking/brake release member of a spring applied hydraulically released vehicle brake system (SAHR), also referred to as a negative brake, the absence of pressure in the actuating device DA means that the brake member OF remains returned against the element to be braked. In other words, when the solenoid valves EV1 and EV2 are not powered, the member OF carries out its braking function. Subsequently, and as described in detail below, if the actuating device DA is pressurized with the line LP via the solenoid valves EV1, EV2, the actuating device DA transmits the feed pressure to the member OF, which is then moved into the brake release position.

When the solenoid valve EV1 is operating correctly and is controlled by being electrically powered, said solenoid valve passes into the so-called activation position, in which the connecting line LR is placed in fluidic communication with the pressure line LP such that the sensor CP1 measures a pressure greater than or equal to the first threshold value. Moreover, when the solenoid valve EV2 is operating correctly and is controlled by being electrically powered, said control being initiated by the control system 130 following a pressure measurement by the sensor CP1 greater than or equal to the first threshold value, said solenoid valve passes into the active position, in which the feed line LA is placed in fluidic communication with the pressure line LP, via the connecting line LR, such that the sensor CP2 measures a pressure greater than or equal to the second threshold value. In the event of faulty operation of a solenoid valve, the associated pressure sensor does not detect a pressure greater than or equal to said threshold values, this meaning that the solenoid valve is not in the activation position that it is supposed to occupy in spite of the electrical control which has been applied to it.

The expression “controlled state” means a controlled state with electric power or with electric power being stopped.

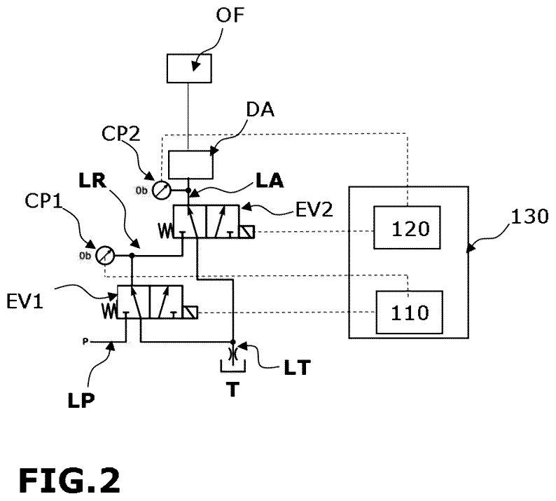

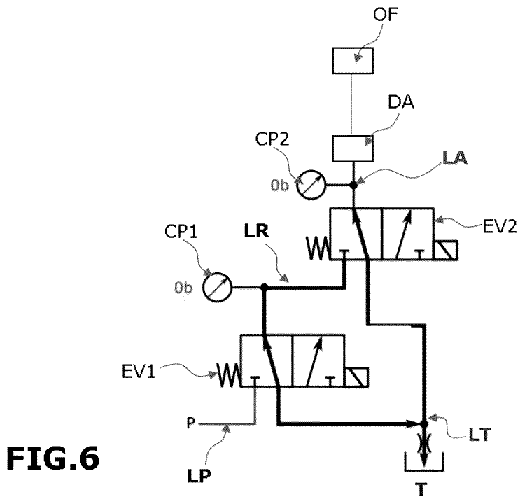

The return or discharge line to the reservoir (or delivery line) LT is connected to the first solenoid valve EV1 and to the second solenoid valve EV2 such that when the solenoid valves EV1, EV2 are in the return position (i.e. are not electrically powered) (see, for example FIG. 2 or FIG. 6), the connecting line LR is in communication with the return line to the reservoir LT via the first solenoid valve EV1 and the feed line LA is in communication with the return line to the reservoir LT via the second solenoid valve EV2.

In other words, the solenoid valve EV1 comprises a discharge path which makes it possible to connect the connecting line LR to the reservoir T, in the return (discharge) position of the solenoid valve EV1 (electric power supply of the solenoid valve being stopped), and a feed path which makes it possible to connect the connecting line LR to the pressure line LP (in the electrically powered state of the solenoid valve). The solenoid valve EV2 comprises a discharge path which connects the feed line LA to the reservoir T in the return (discharge) position of the solenoid valve EV1 (electric power supply of the solenoid valve being stopped), and a second, feed path LP which connects the feed line LA to the connecting line LR in the electrically actuated state of the solenoid valve.

### Default Configuration of the System of Solenoid Valves: Braking

By default, as illustrated in FIG. 2, the second solenoid valve EV2 is left unpowered in order to allow it to be in the return (discharge) position, in which the feed line LA of the actuating device DA of the member OF is in communication with the reservoir T. The first solenoid valve EV1 is also left non-electrically powered in order to allow it to be in the return (discharge) position, in which the connecting line LR is in communication with the reservoir T. As illustrated in FIG. 2, the sensors CP1 and CP2 then measure a pressure of 0 bar (denoted 0 b).

In this default configuration, the actuating device DA does not act on the member OF and so, when the member OF is a braking and brake release member returned into the braking position, said braking member continues to exert a braking force on a machine element to be braked.

### Control of the System of Solenoid Valves for Brake Release

The control system 130 is configured to control the solenoid valves in the following way on receiving a control instruction from the actuating device DA, such as a command for releasing the brake system:

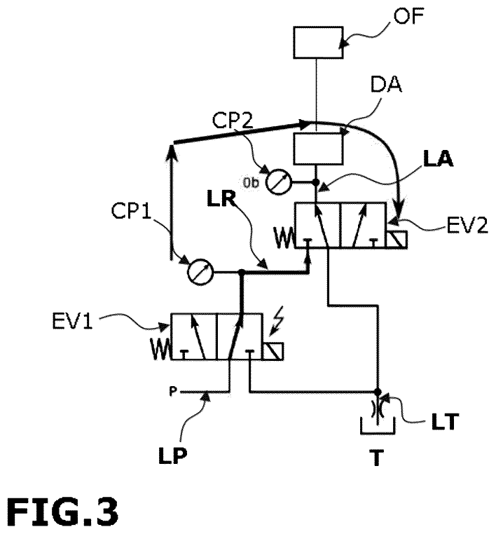

Preferably, in an initial step, the control system 130 verifies that the measured pressures are lower than the threshold values in order to verify that the solenoid valves are in the return (discharge) position. It is thus possible to provide that, if the pressure measured by the sensor CP1 and/or CP2 is greater than or equal to the corresponding threshold value while the control system 130 has not yet transmitted an electric command for passing the solenoid valve EV1, EV2 into an active position, there is a malfunction of the solenoid valve EV1, EV2 which is supposed to be in the discharge (return) position, but which has actually had to remain in the position corresponding to its powered state.
Step a): As illustrated, for example, in FIG. 3, the first solenoid valve EV1 is powered in order to place the connecting line LR in communication with the pressure line LP. The pressure measured by the first sensor CP1 in the connecting line LR is then greater than or equal to the first threshold value.

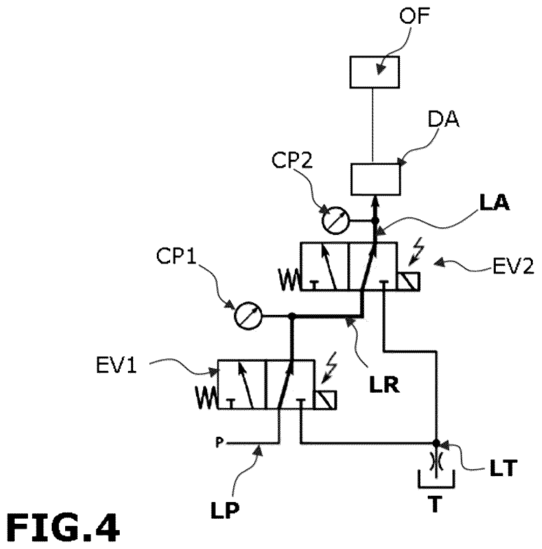

Otherwise, i.e. if the pressure measured by the first sensor CP1 remains lower than said first threshold value in spite of the electric command in step a), a signal indicating detection of a malfunction of the solenoid valve EV1 is emitted. Specifically, in the return position of the solenoid valve EV1, the connecting line LR is supposed to be pressurized by the pressure line LP. It is then possible for the solenoid valve EV1 to have remained in the position corresponding to its unpowered state where the connecting line LR is connected to the reservoir T even though it has received an electric command to move into the activation position.
Step b): As illustrated, for example, in FIG. 3 and in FIG. 4, if the pressure measured by the first sensor CP1 is greater than or equal to said first threshold value, the control system 130, preferably the second control unit 120, causes the second solenoid valve EV2 to be electrically powered so as to place the feed line LA of the actuating device DA in communication with the connecting line LA, which is already in fluidic communication with the pressure line LP via the first solenoid valve EV1. The solenoid valves are thus considered to be operating normally.

Furthermore, provision may be made that, if the pressure measured by the sensor CP2 is greater than or equal to the second given threshold value while the control unit 120 has not yet transmitted an electric command for passing the solenoid valve EV2 into an active position, i.e. between step a) and step b), there is a malfunction of the solenoid valve EV2 which is supposed to be in the discharge (return) position with communication of the feed line LA with the reservoir T, but which has actually had to remain in the position corresponding to its electrically powered state, in which the line LA is connected to the line LR, and thus receives the pressure of the line LP from the electric power supply of the first solenoid valve EV1.

### Control of the System of Solenoid Valves for Braking

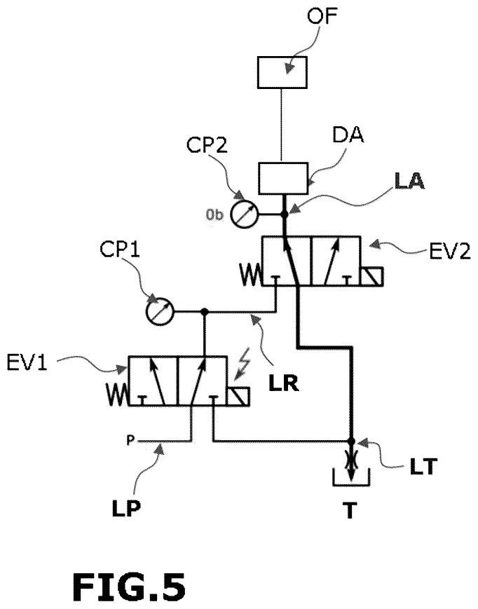

The control units 110, 120 are configured to carry out the following steps on receiving another control instruction from the actuating device (DA), such as a braking control instruction:
Step c): Stopping the electric power supply of the second solenoid valve EV2 to allow it to be returned into the discharge position, in which the feed line LA of the actuating device DA is in communication with the reservoir T. A corresponding example is illustrated in FIG. 5.

Preferably, the control system 130 carries out a step d) corresponding to the stopping of the electric power supply of the solenoid valve EV1. A corresponding example is illustrated in FIG. 6.

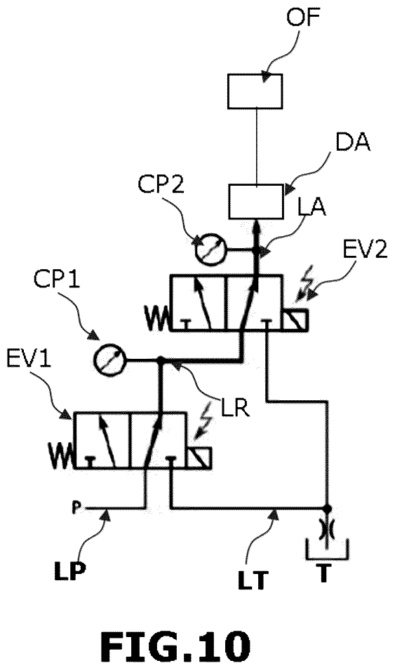

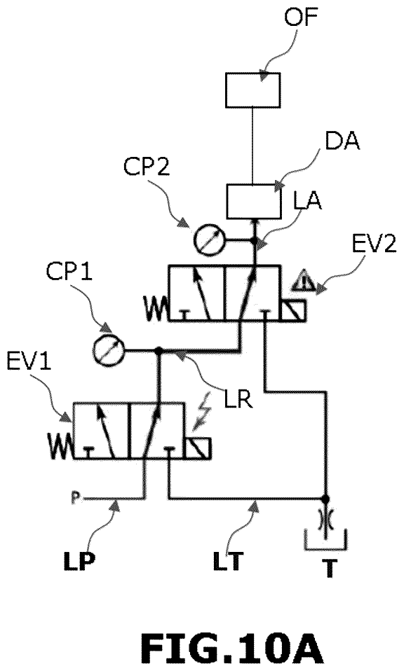

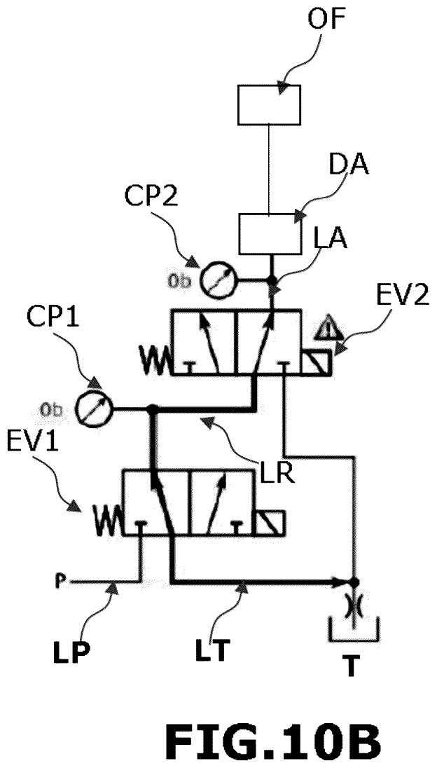

Thus, if the solenoid valve EV2 is locked in the active position, in which the feed line LA is in communication with the connecting line LR (as, for example, in the case of FIGS. 10A and 10B described in detail below), the fact that the solenoid valve EV1 is made to pass into the discharge position makes it possible (in the case of correct operation of the solenoid valve EV1) to place the feed line LA in communication with the reservoir T via the connecting line LR, thereby allowing the oil present in the feed line LA to be delivered into the reservoir T, for example to achieve braking of the machine in spite of the malfunction of the second solenoid valve EV2.

Advantageously, after step c), if the pressure measured by the second sensor CP2 is greater than or equal to the second threshold value, the control system 130 emits a signal indicating detection of a malfunction of the second solenoid valve EV2. Specifically, the second solenoid valve EV2 is probably locked in the powered position while it is not supposed to be powered.

After step d), if the pressure measured by the first sensor CP1 is greater than or equal to the first threshold value, the system emits a signal indicating detection of a malfunction of the first solenoid valve EV1. Specifically, the solenoid valve EV1 is probably locked in the powered position while it is not supposed to be powered.

### Case of Malfunction

For each case of malfunction of at least one of said solenoid valves EV1, EV2, the processing system 10 stops or limits the movement of the machine over the ground and/or stops or limits the actuation of the handling system. This limiting of movement and/or actuation is commanded for as long as the malfunction exists.

In particular, provision may be made that, in the case of malfunction of at least one of said solenoid valves EV1, EV2, the control system 130 generates a malfunction signal which is sent to the processing system 10. The processing system 10 of the machine can then carry out a procedure of putting into safety mode, in which the movement of the machine over the ground and/or the actuation of the handling system 600 is prevented or limited, for as long as the malfunction is not resolved.

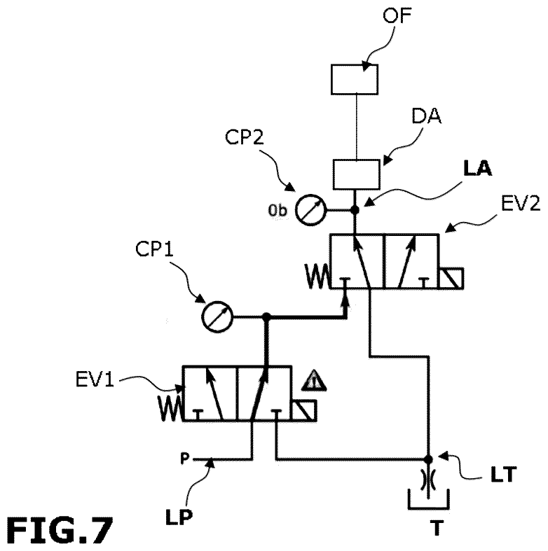

In a first case, as illustrated, for example, in FIG. 7, it is possible for the solenoid valve EV1 to be locked in the active position while it is not being electrically powered. In this case, the pressure sensor CP1 measures a pressure greater than or equal to the first threshold value and the control system 130 then detects an inconsistency between the pressure measured by the sensor CP1 and the fact that the solenoid valve EV1 is not being electrically powered.

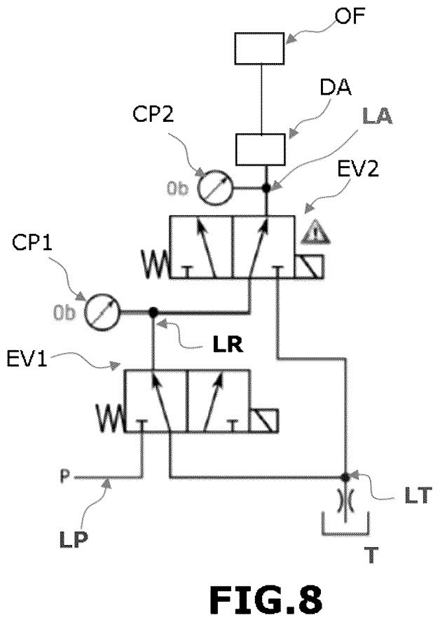

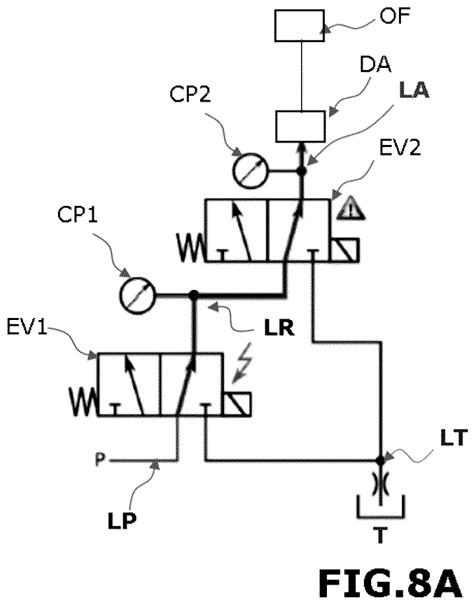

In a second case, as illustrated, for example, in FIG. 8 and in FIG. 8A, it is possible for the solenoid valve EV2 to be locked in the active position while it is not being electrically powered. Initially, as illustrated in FIG. 8, the solenoid valves EV1, EV2 are not powered. As illustrated in FIG. 8A, when the solenoid valve EV1 passes into the hydraulic feed position (active position) by being electrically powered, following a corresponding instruction from the control system, for example for braking purposes, the sensor CP1 measures a pressure greater than or equal to the first threshold value, meaning correct operation of the solenoid valve EV1, but the pressure sensor CP2 measures a pressure greater than or equal to the second threshold valve while the control system has not yet commanded the electric power supply of the solenoid valve EV2 (which is therefore supposed to be in the discharge position). The control system 130 then detects an inconsistency between the pressure measured by the sensor CP2 and the fact that the solenoid valve EV2 is not being electrically powered.

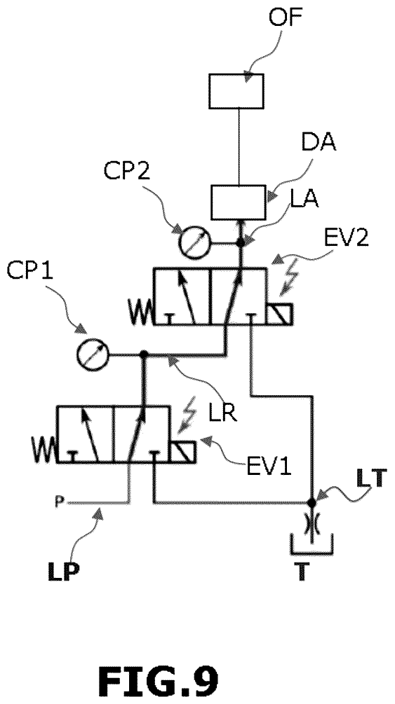

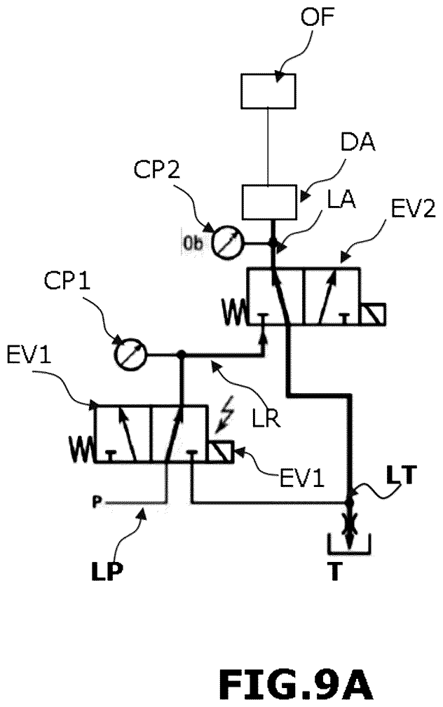

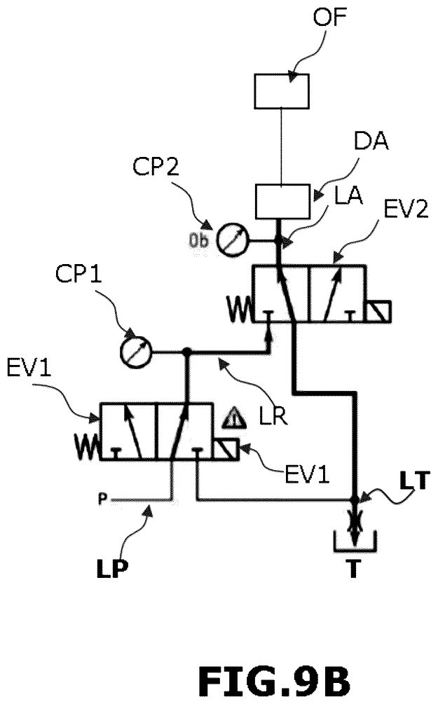

In a third case, as illustrated, for example, in FIGS. 9, 9A and 9B, it is possible for the solenoid valve EV1 to be locked in the active position while it is being powered and for the solenoid valve EV2 also to be in the active position by being electrically powered, but not locked (see FIG. 9). In this configuration, the feed line LA is pressurized such that the actuating device DA actuates the braking and brake release member OF, allowing braking to be released.

When the operator commands braking, the control system 130 stops the power supply of the solenoid valve EV2 so that it is returned into the discharge position, in which the feed line LA is in communication with the discharge line LT, allowing the oil to be delivered into the reservoir T, and thus allowing braking by virtue of the braking and brake release member being returned into its braking position when it is no longer pressurized by the actuating device DA (FIG. 9A). The control system 130 also stops the electric power supply of the solenoid valve EV1. However, as illustrated in FIG. 9B, the solenoid valve EV1 remains locked in the active hydraulic feed position and so, in spite of the electric power supply of the solenoid valve EV1 being stopped, the pressure sensor CP1 measures a pressure greater than or equal to the corresponding first threshold value. The control system 130 thus detects a malfunction of the solenoid valve EV1.

In a fourth case, as illustrated, for example, in FIG. 10, it is possible for the solenoid valve EV2 to be electrically powered and to be locked in the active hydraulic feed position, and for the solenoid valve EV1 to also be in the active position by being electrically powered, but not locked (see FIG. 9). In this configuration, the feed line LA is pressurized such that the actuating device DA actuates the braking/brake release member, allowing braking to be released.

When the operator commands braking, the control system 130 stops the power supply of the solenoid valve EV2 in order to return it into the discharge position, but the solenoid valve EV2 remains locked in the hydraulic feed position, in which the feed line LA is in communication with the connecting line LR. The control system 130 detects that the pressure measured by the sensor CP2 remains greater than or equal to the corresponding second threshold value (in spite of the electric power supply of the solenoid valve EV2 being stopped) and thus detects a malfunction (FIG. 10A) which prevents the discharge of the oil from the feed line LA and therefore braking.

The control system 130 then stops the power supply of the solenoid valve EV1 to return it into the discharge position so as to connect the connecting line LR to the discharge line LT (and no longer to the pressure line LP). Thus, the oil present in the feed line LA is delivered into the reservoir T by the connecting line LR and the discharge line LT, passing through the solenoid valve EV1 (FIG. 10B). The braking member is then no longer pressurized and is returned into the brake release position.

In each case, the control system 130 then generates a malfunction signal and preferably the control system 130 or the processing system 10 carries out a procedure of putting the machine into safety mode, for example by preventing or limiting the movement of the machine and/or of the handling system.

### Control Unit and Processing System

The or each control unit and the processing system are in the form, for example, of a processor and a data memory in which the computing instructions that are able to be executed by said processor are stored, or in the form of a microcontroller.

In other words, the functions and steps described can be implemented in the form of a computer program or via hardware components (for example programmable gate arrays). In particular, the functions and steps carried out by the or each control unit and/or the processing system can be realized by sets of instructions or computing modules implemented in a processor or controller or be realized by dedicated electronic components or components of the programmable logic device type (or FPGA, which is the acronym for field-programmable gate array) or of the application-specific integrated circuit type (or ASIC). It is also possible to combine computing parts and electronic parts.

The or each control unit or the processing system is thus an electronic and/or computer unit or system. Where it is stated that said unit or system is configured to carry out a given operation, this means that the unit or system comprises computing instructions and the corresponding execution means which make it possible to carry out said operation and/or that the unit or system comprises corresponding electronic components.

The invention is not limited to the embodiments illustrated in the drawings. Consequently, it should be understood that, where the features mentioned in the appended claims are followed by reference signs, these signs are included only in order to improve the intelligibility of the claims and have no limiting effect whatsoever on the scope of the claims.

Moreover, the term “comprising” does not exclude other elements or steps. Furthermore, features or steps which have been described with reference to one of the embodiments set out above can also be used in combination with other features or steps of other embodiments set out above.

1. Handling machine comprising a rolling chassis (2), a drive system for moving the machine over the ground, and a handling system (600) carried by the rolling chassis (2), the handling machine also comprising:
a hydraulically actuable member (OF), such as a braking and brake release member;
a hydraulic actuating device (DA) configured to actuate the member (OF);
a hydraulic circuit comprising an oil reservoir (T), a discharge line (LT) communicating with the reservoir, and a pressure line (LP) for actuating said member (OF) when the hydraulic actuating device (DA) is placed in hydraulic communication with the pressure line (LP);
a control system (130) comprising a first control unit (110) and a second control unit (120), and a system of solenoid valves which comprises a first two-way solenoid valve (EV1), which is controllable by the first control unit (110), and a second two-way solenoid valve (EV2), which is controllable by the second control unit (120);
a hydraulic connecting line (LR) between the solenoid valves (EV1 and EV2);
a first sensor, referred to as first pressure sensor (CP1), configured to measure a parameter representative of the hydraulic pressure in the connecting line (LR);
a hydraulic feed line (LA) for the actuating device (DA), which connects the second solenoid valve (EV2) to the actuating device (DA),
a second sensor, referred to as second pressure sensor (CP2), configured to measure a parameter representative of the hydraulic pressure in the feed line (LA);
the first solenoid valve (EV1) being movable between:
a discharge position in the non-electrically powered state of the first solenoid valve (EV1), in which the connecting line (LR) is in communication with the reservoir (T), and
a hydraulic feed position, in the electrically powered state of the first solenoid valve (EV1), in which the connecting line (LR) is in communication with the pressure line (LP),
the second solenoid valve (EV2) being movable between:
a discharge position, in the non-electrically powered state of the second solenoid valve (EV2), in which the feed line (LA) of the actuating device (DA) is in communication with the reservoir (T), and
a hydraulic feed position, in the electrically powered state of the second solenoid valve, in which the feed line (LA) of the actuating device (DA) is in communication with the connecting line (LR);
the control system (130) being configured to detect a malfunction of at least one of the solenoid valves (EV1, EV2) depending on one or more pressures measured by the or one of the pressure sensors (CP1, CP2) and on the electrically powered state of one or more solenoid valves.

2. Machine according to claim 1, wherein, with the machine comprising a processing system (10), which may comprise the control system (130), said processing system (10) making it possible to control the movement of the machine over the ground and the actuation of the handling system,
if a malfunction of at least one of said solenoid valves (EV1, EV2) is detected by the control system (130), the processing system (10) is configured to stop or limit the movement of the machine over the ground and/or to stop or limit the actuation of the handling system.

3. Machine according to claim 1 or 2, wherein, on receiving a first instruction for controlling the actuating device (DA), such as a brake release command, the control system (130) is configured to:
a) power the first solenoid valve (EV1) so as to make it possible to place the connecting line (LR) in communication with the pressure line (LP),
b) if the pressure measured by the first sensor (CP1) is greater than or equal to a first threshold value, and if the pressure measured by the second sensor (CP2) is less than a second threshold value, the second control unit (120) causes the second solenoid valve (EV2) to be electrically powered in order to place the feed line (LA) of the member (OF) in communication with the connecting line (LR) which is already in communication with the pressure line (LP) via the first solenoid valve (EV1),
otherwise, the control system (130) generates a signal indicating detection of a malfunction of at least one of the solenoid valves (EV1, EV2).

4. Machine according to claim 3, wherein, before step a), if the pressure measured by the first sensor (CP1) is greater than or equal to the first threshold value, the control system (130) generates a signal indicating detection of a malfunction of the first solenoid valve (EV1).

5. Machine according to claim 3 or 4, wherein, between steps a) and b), if the pressure measured by the second sensor (CP2) is greater than or equal to the second threshold value, the control system (130) generates a signal indicating detection of a malfunction of the second solenoid valve (EV2).

6. Machine according to any one of the preceding claims, wherein, on receiving a second instruction for controlling the actuating device (DA), such as a braking command, the control system (130) is configured to:
c) cut the electric power supply of the second solenoid valve (EV2) to allow it to be in a discharge position in which the feed line (LA) of the actuating device (DA) is in communication with the reservoir (T),
d) preferably, cut the electric power supply of the first solenoid valve (EV1) to allow it to be in a discharge position in which the connecting line (LR) is in communication with the reservoir (T).

7. Machine according to claim 6, wherein, between steps c) and d), if the pressure measured by the second sensor (CP2) is greater than or equal to the second threshold value, the control system (130), preferably the second control unit (120), is configured to generate a signal indicating detection of a malfunction of the second solenoid valve (EV2).

8. Machine according to claim 6 or 7, wherein, after step d), if the pressure measured by the first sensor (CP1) is greater than or equal to the first threshold value, the control system (130) is configured to generate a signal indicating detection of a malfunction of the first solenoid valve (EV1).

9. Machine according to any one of the preceding claims, wherein the actuating device (DA) comprises a hydraulic valve.

10. Machine according to any one of the preceding claims, wherein the actuating device (DA) comprises a hydraulic distributor.

11. Machine according to any one of the preceding claims, wherein the member (OF) that is actuable by the actuating device (DA) is a braking and brake release member.
